(19) United States
(12) Patent Application Publication
(10) Pub. No.: US 2026/0275904 A1
(43) Pub. Date: Sep. 17, 2026

(54) High-Efficiency Rotary Engine with Perpendicular Force Transmission and Compound Energy Recovery System

(71) Applicant: Liangui na Li, Co Limerick (IE)

(72) Inventor: Liangui na Li, Co Limerick (IE)

(21) Appl. No.: 19/301,940

(22) Filed: Aug. 16, 2025

(51) Int. Cl. F02B 55/08; F02B 29/04; F02B 55/02

(52) U.S. Cl. CPC F02B 55/08; F02B 29/0406; F02B 55/02

(57) ABSTRACT

A novel rotary engine is disclosed featuring a straight-axis rotor and perpendicular force transmission, significantly improving torque efficiency and reducing mechanical loss. The system utilizes modular sealed combustion chambers, with each module executing a simplified three-stage cycle. Exhaust energy is recovered via a turbocharger and heat exchanger, yielding thermal efficiency exceeding 60%. The multi-module configuration ensures continuous torque output with enhanced durability and reduced complexity.

### 1. TECHNICAL FIELD

The present invention pertains to the field of internal combustion engines, and more specifically, to a novel rotary engine architecture designed to enhance torque conversion and thermal efficiency. This is achieved through an optimized mechanical structure and an integrated compound energy recovery system.

### 2. BACKGROUND

Conventional internal combustion engines, including traditional rotary engines such as the Wankel type, rely on crankshaft mechanisms that inherently suffer from torque losses due to non-perpendicular force transmission. Furthermore, a significant portion of energy is dissipated as heat and expelled through exhaust gases, resulting in thermal efficiencies typically below 40%, thus leaving substantial room for improvement.

Although recent advances—such as turbocharging and exhaust heat recovery—have improved performance marginally, mechanical complexity and internal losses remain persistent limitations across most designs.

### 3. BRIEF DESCRIPTION OF THE DRAWINGS

FIG. 1 illustrates the engine's structural configuration of this invention:
1. Intake Valve, driven by a cam mechanism located in the top box. The cam mechanism is driven by Shaft 6 and operates synchronously therewith.
2. Shutter, having two operating positions: open and closed. It is driven by the cam mechanism located in the top box and synchronized with Shaft 6. When the shutter is in the open position, the propeller is allowed to pass through the throat; When the shutter is in the closed position, since its width is slightly greater than that of the rotor passage at the throat, it is blocked by the throat and tightly pressed against it by the pressure. This structure forms a unidirectional sealing engagement, similar to the relationship between a door and a doorframe, and allowing opening and closing only in one direction. The shutter working together with the intake valve/rotor/casing and propeller, forms a sealed combustion chamber in which combustion occurs.

Meanwhile, the shutter is precisely fitted with both the throat and the rotor.
3. Propeller, fixed to the rotor and precisely matched with the casing and rotor. When a pressure difference exists across both sides of the propeller, the pressure differential drives it, thereby rotating the rotor.
4. Body casing.
5. Rotor, rigidly connected to the shaft and precisely fitted with the casing to form an annular working chamber, ensuring that the propeller performs circular motion within the chamber.
6. Shaft
7. Bearing bushing

And exhaust ports remains substantially open

FIG. 2 illustrates the operational flow of the system, showing a three-stage working cycle comprising, in sequence: intake, combustion, pass through the throat, exhaust kinetic energy recycle and optional residual thermal energy recovery.

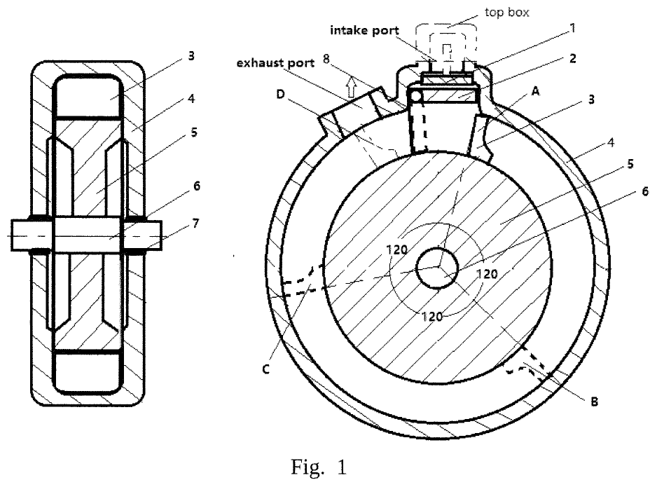

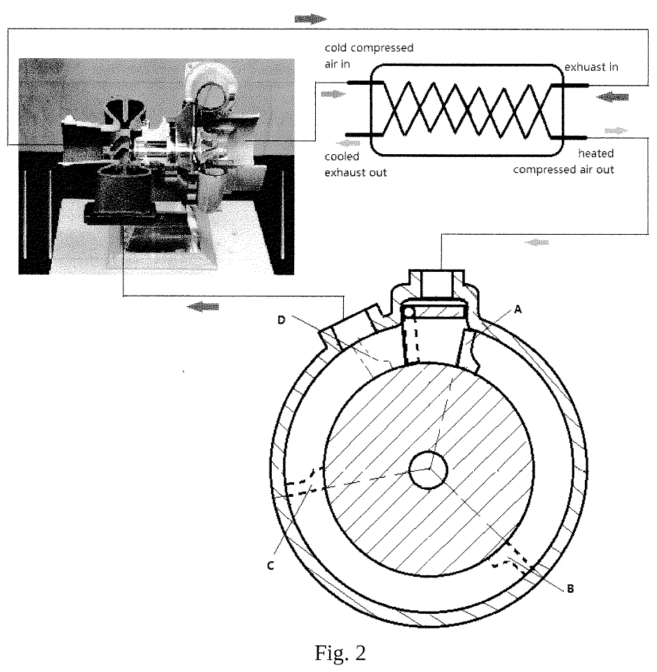

### 4. SUMMARY OF THE INVENTION

Key structural and functional features include:

### 1. Linear Shaft and Perpendicular Force Structure

The rotor is fixed on a linear shaft. The pressure generated during combustion acts perpendicularly on the propeller, ensuring that the pressure is always perpendicular to the lever arm, thereby producing higher driving torque and avoiding angular efficiency losses commonly observed in conventional crankshaft mechanisms.

Although pressure acts on the rotor, the force at any point is directed toward the shaft center, resulting in a near-zero effective lever arm. Consequently, the resisting torque generated by pressure acting on the rotor is relatively small (excluding frictional resistance, as discussed below).

### 2. Modular Sealed Combustion Chamber

Each combustion process occurs within a sealed chamber formed by five cooperating components: the intake valve, shutter, rotor, propeller, and casing.

During rotation, the chamber maintains an annular structure with a constant cross-sectional area (except in the operating region of the shutter).

### 3. Simplified Three-Stage Operating Cycle

Unlike conventional four-stroke engines, or Wankel rotary engine, the present rotary system employs a simplified three-stage cycle:
Intake (admission of air and fuel),
Combustion (ignition within the sealed chamber),
Pass through (propeller passing through the throat).

The exhaust port remains substantially open, allowing exhaust gases to be discharged without mechanical valve control. Since the propeller continuously expels exhaust gases, recovery of exhaust kinetic energy through turbocharging is an advantage for compressing fresh air into the top box, thereby improving fuel efficiency.

### 4. Multi-Module Combination for Continuous Power Output

Three or four identical modules are arranged in series on a common linear shaft. Their propellers are evenly distributed circumferentially on the rotors (e.g., at intervals of 120° or) 90°, causing the modules to operate in different phases.

This configuration enables continuous and smooth torque output with minimal vibration.

### 5. Structural Rigidity and Energy Retention

During combustion, all structural components remain fixed or rigidly supported. No pistons, crankshaft, or shape-changing components exist within the combustion chamber. This design facilitates more effective utilization of pressure, analogous to the pressure acting primarily at the outlet of a sealed gas container.
(1) Casing: The casing exhibits high structural stiffness during combustion. Its displacement and deformation remain relatively small, thereby reducing energy losses caused by structural deformation and allowing more usable energy to be applied to the propeller (excluding leakage effects, as discussed below).
(2) Intake Valve: During combustion, the intake valve is tightly pressed against the casing, exhibiting minimal displacement and deformation, thus reducing deformation-induced energy losses.
(3) Shutter: During combustion, the shutter is tightly pressed against the throat, exhibiting minimal displacement and deformation. Although pressure acts on the shutter, no resisting torque is generated because the shutter is not mechanically connected to the rotor.
(4) Rotor: Although the rotor continuously rotates during combustion, its geometry remains substantially unchanged due to rigid support from the shaft and bearing bushings. Therefore, energy losses caused by structural deformation are relatively small.
(5) Vibration and Friction: Throughout the operating cycle, vibration, noise, and friction levels remain low, which contributes to improved fuel efficiency.

### 6. Optional Energy Recovery Accessories

Although the core of the present invention focuses on the rotary engine itself, the design optionally supports integration with turbochargers and heat exchangers.

These standard components facilitate recovery of exhaust kinetic and thermal energy, thereby improving overall thermal efficiency.

By eliminating conventional reciprocating mechanisms, simplifying the combustion cycle, and maintaining ideal force directions, the rotary engine achieves high torque density and mechanical simplicity, with the objective of potentially exceeding the thermal efficiency of comparable existing engines.

### 5. DETAILED DESCRIPTION OF THE INVENTION

The engine operates through a continuous three-stage cycle: intake, combustion, and pass through the throat. Unlike traditional engines that rely on timed exhaust systems and reciprocating components, the present system employs a simplified rotary structure.

For illustrative purposes, a configuration comprising three identical modules arranged in series is considered, wherein the propellers are positioned at 120° intervals on their respective rotors.

1. Intake Initiation (Module 1 Starting from Point A)

After the propeller of Module 1 exits the operating region of the shutter, the shutter prepares to close while the intake valve prepares to open. Compressed fresh air enters the chamber.

After a certain rotation, the shutter fully closes, and fuel is introduced to form a combustible air-fuel mixture.

2. Combustion (Module 1 Starting from Point B)

The intake valve closes, forming a sealed chamber defined by the rotor, casing, shutter, propeller, and intake valve.

Ignition is initiated, and the generated pressure acts directly on the propeller, driving the rotor to rotate.

All chamber boundaries remain substantially rigid and substaintially undeformed, facilitating efficient conversion of combustion energy into rotational torque.

3. Pass Through the Throat (Module 1 Starting from Point C)

Sufficient pressure remains in the combustion chamber of Module 1 to sustain rotation. After a certain displacement, the shutter opens, allowing the propeller to pass through the throat.

Meanwhile, Modules 2 and 3 operate at phase-shifted positions, ensuring that at least one module is in the combustion stage at any given time, thereby achieving continuous and stable torque output.

Operation sequence of three modules:

| rotor | | | |
|---|---|---|---|
| position | module 1 | module 2 | module 3 |
| A | intake | combustion | pass through |
| B | combustion | pass through | intake |
| C | pass through | intake | combustion |

By eliminating complex reciprocating components, the engine achieves high reliability, low friction, and simplified manufacturing.

Exhaust gases are continuously discharged and may optionally pass through turbochargers and heat exchangers for energy recovery, further improving fuel efficiency, although these components are not part of the present invention.

1. A rotary engine comprising:
1. a rotor rotatable about a fixed straight axis;
2. a set of propellers securely mounted on the rotor;
3. a fixed engine casing cooperating with a shutter, propeller and intake valve to form a sealed combustion chamber;
4. a combustion-driven force configured to act substantially perpendicular to a torque arm;
5. permanently open exhaust ports, configured to allow continuous expulsion of combustion gases without valve actuation.
Wherein the rotary engine is configured to provide continuous torque output with improved thermal efficiency and reduced mechanical losses.

2. The rotary engine of claim 1, wherein the system comprises three or more identical combustion modules which propellers evenly distributed around the rotor at substantially uniform angular intervals, each operating sequentially in intake, ignition, and pass through phases.

3. The rotary engine of claim 1, wherein the shutter and intake valve are mechanically synchronized with rotor via a cam system.

4. The rotary engine of claim 1, wherein, during a combustion process, a force vector generated by combusion remains substantially perpendicular to a radius extending from a shaft center.

5. The rotary engine of claim 1, further comprising a turbocharger and a heat exchanger (optional) forming an integrated energy recovery system configer to reuse kinetic and thermal energy from exhaust gases.
